(19) United States
(12) Patent Application Publication
(10) Pub. No.: US 2013/0313948 A1
(43) Pub. Date: Nov. 28, 2013

(54) Electric Motor/Generator With Multiple Individually Controlled Turn-Less Structures

(71) Applicant: Oved Zucker, Annandale, VA (US)

(72) Inventor: Oved Zucker, Annandale, VA (US)

(21) Appl. No.: 13/844,347

(22) Filed: Mar. 15, 2013

Related U.S. Application Data
(60) Provisional application No. 61/651,071, filed on May 24, 2012.

(51) Int. Cl. H02K 11/00; H02K 15/00

(52) U.S. Cl. CPC H02K 11/0073; H02K 15/00
USPC 310/68 D; 29/596

(57) ABSTRACT

A topological change in motor philosophy based on a turn-less stator that is coupled to independent inverters with separate drives is presented herein. The turn-less stator has a multitude of parallel H bridges and an extremely low impedance. This combination of a turn-less stator and independent inverters is unlike conventional motor and actuator technology that requires multi-turn windings for impedance matching with conventional high impedance power systems.

### CROSS-REFERENCE TO RELATED APPLICATION

The current application claims priority under 35 U.S.C. §119(e) to U.S. Provisional patent application Ser. No. 61/651,071, filed on May 24, 2012 and entitled “Electric Motor/Generator with Individually Driven Multiple Poles,” which is incorporated by reference herein in its entirety.

### TECHNICAL FIELD

The subject matter described herein relates generally to motors, generators, and actuators.

### BACKGROUND

The field of motor and generator design is very broad. A major sub-category includes both synchronous and induction motors and generators, where a rotating or, more generally speaking, a traveling magnetic field is generated with the aid of inverters. The inverters use switches such as IGBTs (insulated-gate bipolar transistors) or MOSFETs (metal-oxide-semiconductor field-effect transistors), and where controlled by a microprocessor, generate the appropriate currents at the appropriate frequency in appropriate windings using pulsed width modulation (PWM).

The numbers of poles used depends on the desired rpm relative to the electrical frequency of the generated currents. Such multiple pole systems have the appropriate coils connected in series, parallel, or in a combination of both, as required. These multiple pole systems are driven by a single inverter.

Motors invariably use windings composed of multiple turns. Multiple turns increase the generated back EMF (electromotive force) per winding, and thereby the voltage. Thus, the circuit connections to the motor are reduced to very few connections. Even so, windings, by their very nature, occupy additional space external to the motor's active region by having to provide a return path between turns. This portion of the winding introduces inductance with its attendant reactive energy and power, which requires additional driving voltage and adds to the weight and volume of the motor.

The power density (power per volume) for semiconductor switches can generally depend on both the voltage and their packaging. A larger current density can typically be achieved from both cooling and efficiency considerations when the voltage is reduced, since the semiconductor device thickness is also reduced. Low voltage can also allow for decreasing the distance between devices with attendant compactness.

Generally, in ferromagnetic-based motors, the weight and volume of the stator and rotor structures is proportional to the pole size. Reducing the pole size reduces the weight and volume but also increases the dissipation. Thus, smaller pole motors have a higher power density and a superior surface to volume, which provides more effective heat removal.

It is also recognized that electric motors benefit from having a magnetic flux air gap that is as small as possible. Such a magnetic flux air gap is realized by bearings, or like structures, in linear systems for keeping the rotor centered. The smallest practical magnetic flux air gap is determined by the quality of the bearing and the motor's surface velocity. Therefore it can be desirable to provide appropriate magnetic forces that will maintain the rotor centered. Passive magnetic systems exist that provide magnetic levitation but the produced force is a function of the velocity. They are also separate from the motor magnetic system proper and add weight and volume to the system.

Lastly, it is recognized that the planar nature of MEMS processing which allows the deposition of conductors into grooves in ferromagnetic material is not practical when multi turns windings are used since the various conductors have to be interconnected across the motor system.

Current systems and methods are characterized by performance limitations in terms of power density in the motor and inverter, effective cooling, response time and manufacturing technology. The object of the methods, apparatus, and systems described herein is to address most or all of these issues.

### SUMMARY

In one aspect, a device is provided that includes a turnless, three-phase winding; and a H-bridge inverter. In such devices the turnless, three-phase winding includes three single conductors connected at one end. The connected single conductors form a Y-network configuration, three-phase circuit in such devices.

In a related aspect, a system is provided that includes two or more controllable, turnless devices and a master microprocessor configured to control each controllable, turnless device independently. Each controllable, turnless device includes a turnless, three-phase winding and an H-bridge inverter. The system also includes a power source or a load.

In another related aspect, a method that includes creating a turnless, three-phase winding; creating an H-bridge inverter; connecting the turnless, three-phase winding and H-bridge inverter to make a controllable, turn-less structure is provided herein.

In some variations one or more of the following can optionally be included. The method can further include connecting a DC power source to the turnless, three-phase winding and H-bridge inverter. Assembling multiple controllable, turn-less structures into a suitable configuration with a single, master microprocessor can also be a part of the method in some implementations.

In some apparatus or systems, a linear or circular motor having moving armature and stator is provided, where said stator has multiple side-by-side individually controllable turn-less structures, where each such structure is built from a Turnless Three-phase Winding, henceforth abbreviated TTW, created by shorting at one end three single conductors to form a Y-network configuration three-phase circuit, and energized independently with three coupled properly phased sinusoidal currents produced via an in matching relationship H-bridge H-bridge inverter, said H-bridge conductively connected with a DC source, wherein said stator is controlled by a single master processor to produce coherent motion of said armature.

In other apparatus or systems, a generator having moving armature and stator is provided, where said stator has multiple side-by-side individually controllable turn-less structures, where each such structure is built from a Turnless Three-phase Winding, henceforth abbreviated TTW, created by shorting at one end three single conductors to form a Y-network configuration three-phase circuit, and producing independently three coupled properly phased sinusoidal currents via an in matching relationship H-bridge inverter, said H-bridge conductively connected to a DC load, such as charging a battery, wherein said stator is controlled by a single master processor to produce coherent voltage due to motion of said armature.

In some such apparatus or systems, the H-Bridge can have two halves, each half utilizing three trains of conductively interconnected semiconductor switches such as MOSFETs or IGBTs, branching to the respective three conductors of the TTW at the approximate midpoint between halves. Alternatively, when the apparatus or system includes a linear or circular motor, the DC source can be a capacitor serving as a transitory DC source, advantageously conductively connected to the input side of the H-bridge with plus and minus rail conductors or the DC source can be an energy storage battery providing low voltage continuous charging, advantageously conductively connected to the input side of the H-bridge with plus and minus rail conductors.

Some apparatus or systems can include a DC source that is in the form of separate DC storage batteries to provide continuous charging in series or in series plus parallel groups of said turnless structures at higher voltage than afforded in a strictly parallel arrangement of the same turnless structures, whereby similar power supply characteristics to that of multi-winding systems can be attained with the added benefit of confining AC currents to only the individual turnless structures and therefore having the effect of cancelling all external interconnection inductance limitations and consequently reducing electromagnetic noise and EMI shielding requirements with the attendant weight saving.

Additionally, in some apparatus or systems, the mater microprocessor provide a variety of switching commands to the distributed H-bridge inverters to produce: a) a coherently traveling or revolving magnetic field enabling motion of the armature; b) dynamic feedback centering forces to control the flux gap based on appropriate sensor inputs; c) isolation of failed sections by switching them out; d) reduction in the number of working sections at low loads; e) axial force to balance any applied thrust with appropriate stator shapes such as conical, double conical or rounded structures, whereby these actions can be used in many desirable functional configurations such as active levitation, smaller gap with less expensive bearings, higher efficiency, graceful degradation from individual turnless structure failures. Additionally, the mater microprocessor can provide providing switching commands to the variously located H-bridge inverters in a Pulse Width Modulation manner.

Some apparatus or systems can include a motor according or generator where the magnetic flux gap is radial as in a drum-shaped device and where the rotating armature is either internal or external to the stator, or where the magnetic flux gap is axial as in a disc-shaped device. In such apparatus or systems, the axial field can be controlled to buck a dynamic axial force while dynamically maintaining a constant flux gap by means of aforementioned master microprocessor.

In some apparatus or systems as described above, conductors of the TTWs can be substantially of square cross-section and embedded in slots via thin insulation in a stator matrix, whose material is advantageously ferromagnetic and of thickness twice the side of said square cross-section of the conductors, and where the conductors are advantageously disposed flush with the matrix surface on the flux gap side and spaced apart by a distance equal to the side of the cross-section. In such apparatus or systems, the size of the conductors can represent the pole size of the motor or generator being sufficiently small for the turnless stator structure to accommodate a large number of poles to attain high power density while maintaining a high surface to volume ratio for enhanced cooling and device efficiency is maintained acceptably high.

Some apparatus or systems include a drum-shaped device, that may be, in an initial design phase, constructed as a multifaceted regular polygon with number of facets equal to the number of poles being a whole-number divisional by 6 and, to have a substantially smooth cylindrical bore, the relative difference between the corner radius and the inside radius of a facet being less than about 0.01%, where from geometry of regular polygons is evaluated the number of poles not to be less than 222 with a corresponding stator thickness to radius ratio of less than 2.8%.

In some of the apparatus and systems described above, the stator matrix can be planar, at least in an initial stage of fabrication, facilitating producing the conductor slots with Micro-Electro-Mechanical Systems (MEMS) technology and after coating the slots with a thin layer of insulation depositing in the same slots conductive material by means of electroplating, whereby economic production of small pole sizes, e.g., in the mm or even sub mm range, is made feasible.

The H-bridge inverters of some of the apparatus and systems described above can be manufactured using PCB technology applied to a thin flat sheet of composite material then folded to have a U shaped cross-section with the two legs of the U representing said halves of the H-bridge and having outside dimension between U-legs, including embedded switch wafers, not exceeding the thickness of the aforementioned stator matrix to attain a compact stator assembly. In such apparatus and systems, a number of H-bridges can be printed and assembled to form a contiguous assembly encompassing as many of aforementioned TTWs, whereby is attained improved economy in manufacture. Additionally, in such apparatus and systems, an outside dimension between U-legs of said H-bridges can be sufficiently small relative to the radius of curvature of a drum-shaped device or having a limiting ratio as stated above, i.e. where the relative difference between the corner radius and the inside radius of a facet being less than about 0.01%, where from geometry of regular polygons is evaluated the number of poles not to be less than 222 with a corresponding stator thickness to radius ratio of less than 2.8%, to permit elastic deformation shaping into a partial or full annular assembly, followed by relaxation curing, to conform to the curvature of the same drum shaped device

A stator matrix in apparatus and systems described herein can be planar, at least in an initial stage of fabrication, facilitating producing the conductor slots with Micro-Electro-Mechanical Systems (MEMS) technology and after coating the slots with a thin layer of insulation depositing in the same slots conductive material by means of electroplating, whereby economic production of small pole sizes, e.g., in the mm or even sub mm range, is made feasible.

An H-bridge can be manufactured using PCB technology applied to a thin flat sheet of composite material then folded to have a U shaped cross-section with the two legs of the U representing said halves of the H-bridge and having outside dimension between U-legs, including embedded switch wafers, not exceeding the thickness of the aforementioned stator matrix to attain a compact stator assembly in methods described herein. In such methods, a number of said H-bridges can be printed and assembled to form a contiguous assembly encompassing as many of aforementioned TTWs, whereby is attained improved economy in manufacture.

In some apparatus and systems, the outside dimension between U-legs of said H-bridges can be sufficiently small relative to the radius of curvature of a drum-shaped device or having a limiting ratio in which the relative difference between the corner radius and the inside radius of a facet is less than about 0.01%, where from geometry of regular polygons is evaluated the number of poles not to be less than 222 with a corresponding stator thickness to radius ratio of less than 2.8% to permit elastic deformation shaping into a partial or full annular assembly, followed by relaxation curing, to conform to the curvature of the same drum shaped device.

In some apparatus and systems described herein, the operation of the motor can have a large ratio of peak to average power and where the high power regime is at a tolerably lower efficiency.

A hybrid vehicular or aircraft propulsion system having a small sized fuel burning electric power generation unit coupled to power storage batteries integrated with a motor to provide continuous charging in series or in series plus parallel groups of said turnless structures at higher voltage than afforded in a strictly parallel arrangement of the same turnless structures, where said motor operates at relatively low power during substantially steady state high efficiency cruising mode but giving forth a burst of power at tolerably reduced efficiency during acceleration or scram mode for a brief period of time, whereby said electric power generation unit can be small and light weight and operated at maximum efficiency conditions, all of which contributes to substantially reduced fuel consumption can be included in some apparatus and systems, as described herein.

In some apparatus and systems can include: a rim motor driven ducted ring-fan propulsor for an aircraft comprising a drum shaped motor where the magnetic flux gap is radial as in a drum-shaped device and where the rotating armature is either internal or external to the stator and magnetic thrust bearing, wherein the axial field is controlled to buck a dynamic axial force while dynamically maintaining a constant flux gap by means of aforementioned master microprocessor, and modular high performance batteries providing continuous charging at moderate voltage, that provide continuous charging in series or in series plus parallel groups of said turnless structures at higher voltage than afforded in a strictly parallel arrangement of the same turnless structures, whereby similar power supply characteristics to that of multi-winding systems can be attained with the added benefit of confining AC currents to only the individual turnless structures and therefore having the effect of cancelling all external interconnection inductance limitations and consequently reducing electromagnetic noise and EMI shielding requirements with the attendant weight saving, where the rotor armature is integrated with the ring of the ring-fan, and the motor operated at relatively low power during substantially steady state high efficiency cruising mode but giving forth a burst of power at tolerably reduced efficiency during acceleration or scram mode for a brief period of time, whereby said electric power generation unit can be small and light weight and operated at maximum efficiency conditions, all of which contributes to substantially reduced fuel consumption, whereby better than 99% motor efficiency is attained in cruising mode and with the motor weighing less than around 0.15% of the aircraft total flight weight.

Systems and methods consistent with this approach are described as well as articles that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

Implementations of the current subject matter can provide one or more advantages. For example, the methods, apparatus, and systems that include controllable, turn-less structures with a turnless three-phase winding and an H-bridge inverter can exhibit an increase in the over-all power density of motors, generators, or actuators at any given surface velocity. This can be particularly important for low velocity, low RPM systems.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 shows an assembled Controlled Turnless Structure, CTS base module;

FIG. 2 shows an exploded view of the same CTS in FIG. 1;

FIG. 3 shows a U-shaped, 3-phase array H-bridge;

FIG. 4a and FIG. 4b show two variations of capacitor or battery connected to an H-bridge;

FIG. 5 shows an elemental dipole element, or portion of slow moving platform, or disk motor, or spread out drum motor;

FIG. 6a and FIG. 6b show plots of the power density for respective cases with and without battery both as a function of pole size, and parametrically with efficiency all with a surface velocity of 30 m/s;

FIG. 6c shows a plot of power dissipation as a function of pole size, parametrically with efficiency all with a surface velocity of 30 m/s;

FIG. 7a and FIG. 7b show respectively force density (N/kg) and power density (N/kg) as a function of pole size for shuttle traveling at 1 m/s parametrically with efficiency;

FIG. 8 shows CTSs connected to external DC supply in a series parallel configuration;

FIG. 9 illustrates theoretical multiple CTS stator arranged in a motor drum configuration with exaggerated large thickness to radius ratio for clarity of presentation;

FIG. 10 illustrates a possible principle for lay-out of H-bridge strings matching TTWs arranged to form drum shaped stator having fairly high thickness to radius ratio;

FIG. 11 illustrates multiple clusters of CTSs in a motor stator disk configuration;

FIG. 12 shows a section of a nacelle-ring fan assembly, including drive motor with integrated batteries in which the pole size dimension is over-sized to demonstrate the lay-out principle;

FIG. 13 shows a magnified view of section of nacelle-ring fan assembly;

FIG. 14 shows a ring-fan with attached permanent magnets on the outer and side ring surfaces;

FIG. 15 shows a further magnification, in an orthogonal view, of the rim motor driven ring fan; and

FIG. 16 shows a process flow diagram illustrating aspects of a method having one or more features consistent with implementations of the current subject matter.

When practical, similar reference numbers denote similar structures, features, or elements.

### DETAILED DESCRIPTION

To address the aforementioned, and potentially other, issues that occur with currently available electric motor approaches, implementations of the current subject matter can provide methods, systems, articles or manufacture, and the like that can, among other possible advantages, provide a fundamental topological change in motor philosophy based on a turn-less stator with a multitude of parallel H bridges. Such a configuration can feature extremely low impedance and, when coupled to independent inverters with separate drives, can present a significant improvement relative to conventional motor and actuator technology requiring multi turn windings for impedance matching with conventional high impedance power systems. A multi-turn winding exhibits large parasitic inductance in the return paths, which uses space and requires additional voltage and inductive energy.

Implementations of the current subject matter, as well as any of its derivative electric linear and circular motor/generator variations can include a stator that is schematically assembled with multiple, side-by-side separately controllable turn-less structures, via a single master processor producing coherent motion of the armature, or as in the case of a generator maintaining constant voltage deriving from dynamic motion of the armature.

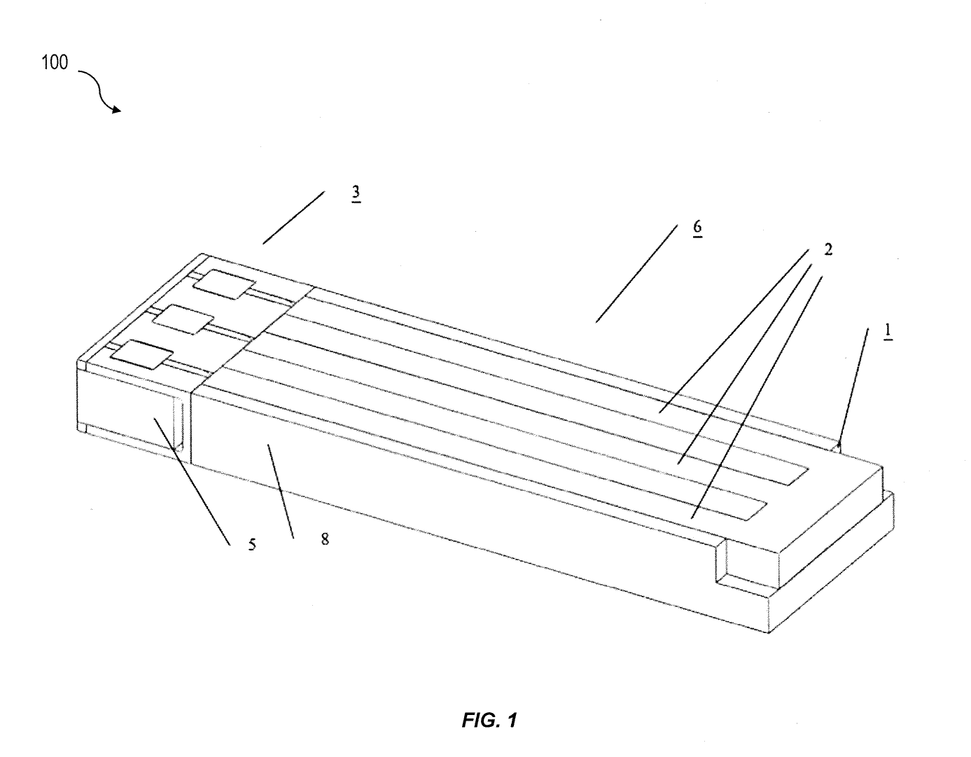

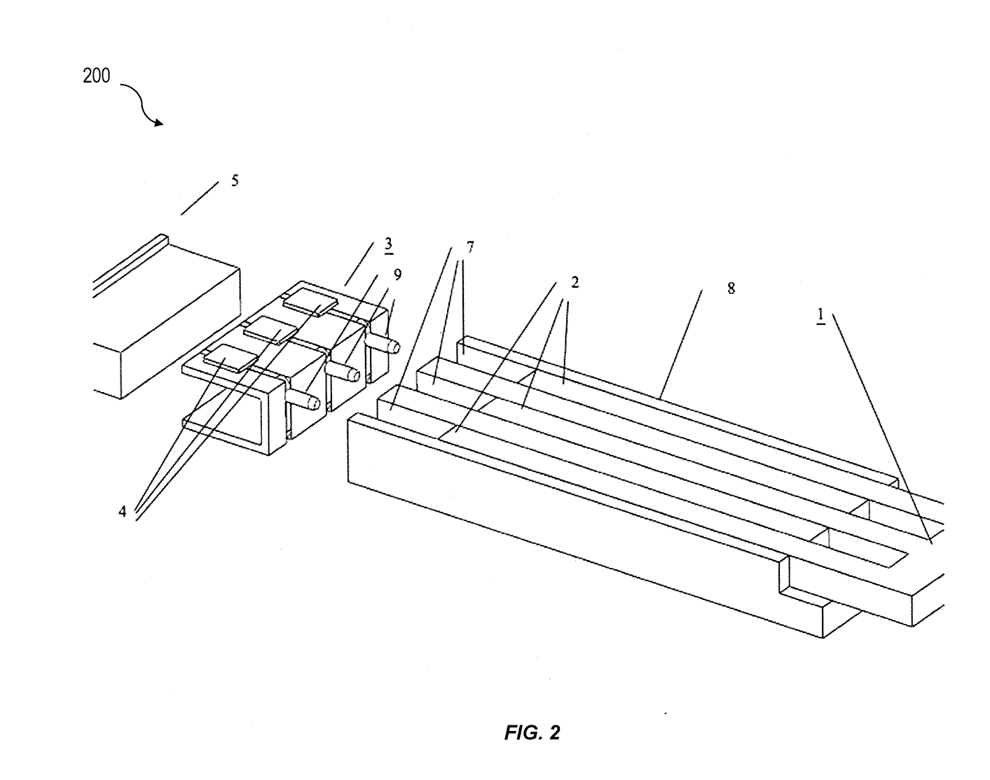

As shown in FIGS. 1 and 2, each Controllable Turn-less Structure 6, henceforth abbreviated CTS, comprises a Turnless Three-phase Winding 1, henceforth abbreviated TTW, and an H-bridge inverter 3. When the CTS is a part of a motor, the CTS includes a DC source. When the CTS is a part of a generator, a DC load is present in the CTS.

A TTW 1 can be created by shorting three single conductors 2 at one end to form a Y-network configuration, three-phase circuit. With a motor, the TTW 1 is energized independently with three coupled, properly phased, sinusoidal currents produced via in matching relationship the H-bridge inverter 3, and this is conductively connected with a DC source, such as a small capacitor of battery cell 5.

In the case of a generator application the TTW 1 produces independently three coupled properly phased sinusoidal currents via in matching relationship the H-bridge inverter 3 which is conductively connected to a DC load, e.g. charging an internal battery cell 5 or external storage battery.

Conductor slots 7 in the stator matrix 8, which can advantageously be made from ferromagnetic material, can be created by various methods, e.g. by MEMS technology allowing production of small pole sizes, e.g. in the mm or even sub mm range. Insulating surfaces can then be deposited into the slots which are then filled by copper electroplating to produce large areas with many TTWs. Small pole size result in a an increase of surface to volume ratio of the turnless structure without affecting the power density or the efficiency and enhances the cooling which is important in some applications. The master microprocessor provides a variety of switching commands to variously disposed H-bridge inverters 3 in the stator to produce: a) a traveling magnetic field enabling rotation in a motor, or linear motion in an actuator, as the case may be; b) dynamic feedback centering forces to control the gap based on appropriate sensor inputs; c) isolation of failed sections by switching them out; d) reducing the number of working section at low loads; e) axial force to balance any applied thrust with appropriate stator shapes such as conical, double conical or rounded structures. These actions can be used in many desirable functional configurations such as active levitation, smaller gap with less expensive bearings, higher efficiency, graceful degradation from individual CTE failure. The apparatus and systems described herein can use individual DC storage batteries in lieu of, or supplementing, the capacitors 5, in the CTEs 6. Such substitution or supplementing allows for continuous charging in series or in a series plus parallel arrangement of groups of CTEs at much higher voltage. This continuous charging at a much higher voltage provides similar power supply characteristics to that of multi winding system. Thus, AC currents are confined to only the individual CTEs 6, having the effect to cancel all external interconnection inductance limitations. The electromagnetic noise produced by this arrangement is drastically reduced which in turn reduces the EMI shielding requirements with their associated weight.

The stator architecture is described in varying configurations, including those in which the moving armature electromagnetic design includes Permanent Magnets (PM), although a passive winding is also possible. Also, the PMs can be arranged in a ferromagnetic matrix with spacing between magnets about equal to the magnet dimension. A so-called Halbach array, providing a contiguous placement of small sized magnets, can also, or alternatively, be used.

A number of independent features can be combined to increase the over-all power density, both in terms of power per volume and power per unit weight, of motors/generators and actuators at any given surface velocity which becomes particularly important for low velocity, low rpm systems. The novel independent, but mutually compatible, contributing features are described:

i. The conductors 2 of the TTWs 1 are advantageously substantially of square cross-section and embedded in slots 7 via thin insulation in a stator matrix 8, whose material is advantageously ferromagnetic and of thickness twice the side of the square cross-section of the conductors 2, and where the conductors are advantageously disposed flush with the surface of the matrix 8 on the flux gap side and spaced apart by a distance equal to the side of the cross-section.

ii. Advantageously the size of the conductors 2 representing the pole size of the motor or generator is sufficiently small for the turnless stator structure to accommodate a large number of poles to attain high power density while maintaining a high surface to volume ratio for enhanced cooling and device efficiency is maintained acceptably high.

iii. The stator matrix 8, is advantageously planar, at least in an initial stage of fabrication to facilitate producing the conductor slots with Micro-Electro-Mechanical systems (MEMS) technology and after coating the slots 7 with a thin layer of insulation depositing in the same slots conductive material by means of electroplating, whereby economic production of small pole sizes, e.g., in the mm or even sub mm range, is made feasible.

iv. The H-Bridge inverter 3 has two halves each half utilizing three trains of conductively interconnected semiconductor switches 4 such as MOSFETs or equivalent semiconductor switches, branching to the respective three conductors 2 of the TTW 1 at the approximate midpoint between halves. DC source or load is conductively connected on their input/output side of the switches 4 via plus/minus rail conductors 10.

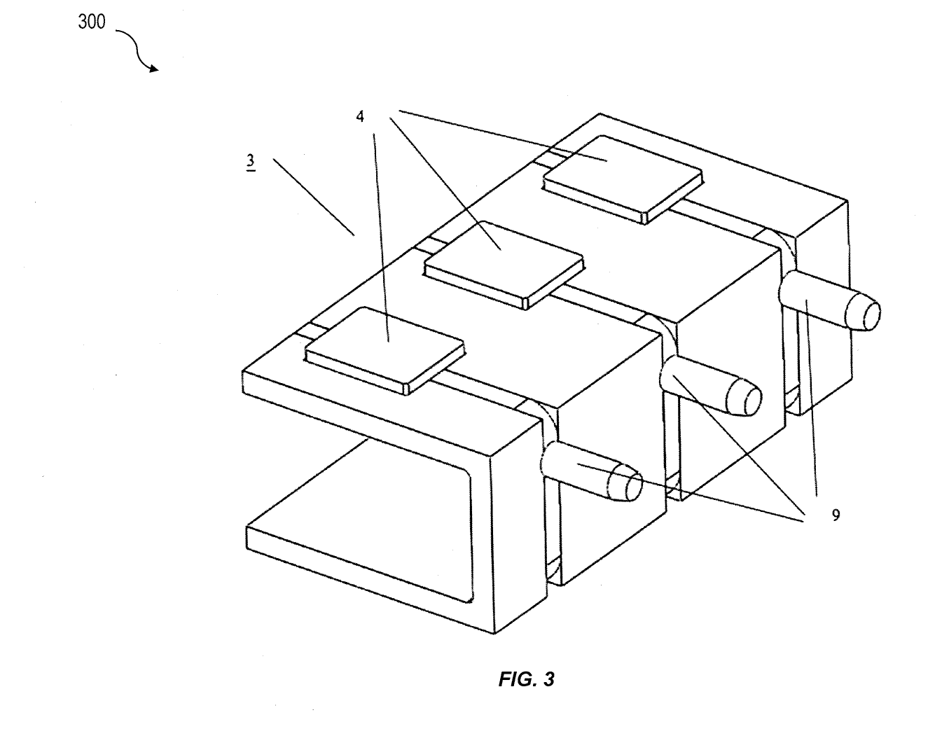

v. Advantageously the H-bridge 3 is manufactured using PCB technology applied to a thin flat sheet of composite material then folded to have a U-shaped cross-section, see FIGS. 1 and 3, with the two legs of the U representing the halves of the H-bridge 3 and having outside dimension between U-legs, including embedded switch wafers 4, not exceeding the thickness of the aforementioned stator matrix to attain a compact stator assembly.

vi. Advantageously a number of the H-bridges 3 are printed and assembled to form a contiguous assembly encompassing as many of aforementioned TTWs 1, whereby is attained improved economy in manufacture.

vii. Advantageously in a drum-shaped device, in an initial design phase the stator is constructed as a multifaceted regular polygon with number of facets equal to the number of poles being a whole-number divisional by 6. In addition, in order to have a substantially smooth cylindrical bore, the relative difference between the corner radius and the inside radius of a facet it is estimated should be less than about 0.01%, where from geometry of regular polygons it is evaluated the number of poles not to be less than 222 with a corresponding stator thickness to radius ratio of less than 2.8%.

viii. Advantageously the outside dimension between U-legs of the H-bridges 3 is sufficiently small relative to the radius of curvature of a drum-shaped motor or generator, as the case may be, to permit elastic deformation shaping into a partial or full annular H-bridge assembly 32, followed by relaxation curing, to conform to the curvature of the same drum shaped device.

ix. The multiple, individually driven CTSs 6 are controlled by a single master microprocessor which may provide a variety of switching commands to the variously located H-bridge inverters 3 in a Pulse Width Modulation manner, to produce: a) a traveling magnetic field enabling rotation, or linear motion in an actuator, as the case may be; b) dynamic feedback centering forces to control the gap based on appropriate sensor inputs; c) isolate failed sections by switching them out; d) reduce the number of working section at low loads; e) axial force to balance any applied thrust with appropriate stator shapes such as conical, double conical or rounded structures. These actions can be used in many desirable functional configurations such as active levitation, smaller gap with less expensive bearings, higher efficiency, graceful degradation from individual CTS failure.

x. Using individual DC storage batteries in lieu of, or supplementing, the capacitors 5, incorporated in the CTSs 6, provides continuous charging in series or in series plus parallel of groups of CTSs at much higher voltage than afforded in a strictly parallel arrangement of the same CTSs, whereby similar power supply characteristics to that of multi-winding systems can be attained with the added benefit of confining AC currents to only the individual CTSs and therefore having the effect of cancelling all external interconnection inductance limitations and consequently reducing electromagnetic noise and EMI shielding requirements with the attendant weight saving.

xi. The CTSs 6 allow configuring the motor or generator differently. Thus, the respective devices may have axial or radial magnetic flux gaps and have the moving armature on either side of the stator.

xii. A magnetic thrust bearing device may be configured with a disk-shaped device, wherein the axial field is controlled to buck a dynamic axial force while dynamically maintaining a constant flux gap by means of aforementioned master microprocessor.

The motor, as described herein, can be operated having a large ratio of peak to average power and where the high power regime is at a tolerably lower efficiency. So for example, a hybrid vehicular or aircraft propulsion system having a small sized fuel burning electric power generation unit coupled to power storages batteries are integrated with a motor, where the motor operates at relatively low power during substantially steady state high efficiency cruising mode but giving forth a burst of power at tolerably reduced efficiency during acceleration or scram mode for a brief period of time, whereby the electric power generation unit can be small and light weight and operated at maximum efficiency conditions, all of which contributes to substantially reduced fuel consumption.

Another specific application seems particularly well suited, namely a rim motor driven ducted ring-fan propulsor for an aircraft comprising a drum shaped motor with magnetic thrust bearing and modular high performance batteries providing continuous charging at moderate voltage, all according to the methods, apparatus, and systems described herein. Here the rotor armature is integrated with the ring of the ring-fan. The motor is operated having a large ratio of peak to average power substantially as described above, whereby better than 99% motor efficiency is attained in cruising mode and with the motor weighing less than around 0.15% of the aircraft total flight weight.

Referring to FIGS. 1 and 2 showing the CTS basic building block, as already described in the above summary, the elements of the CTS will be described in more detail hereunder.

### The H-Bridge and State of the Art of MOSFET Technology

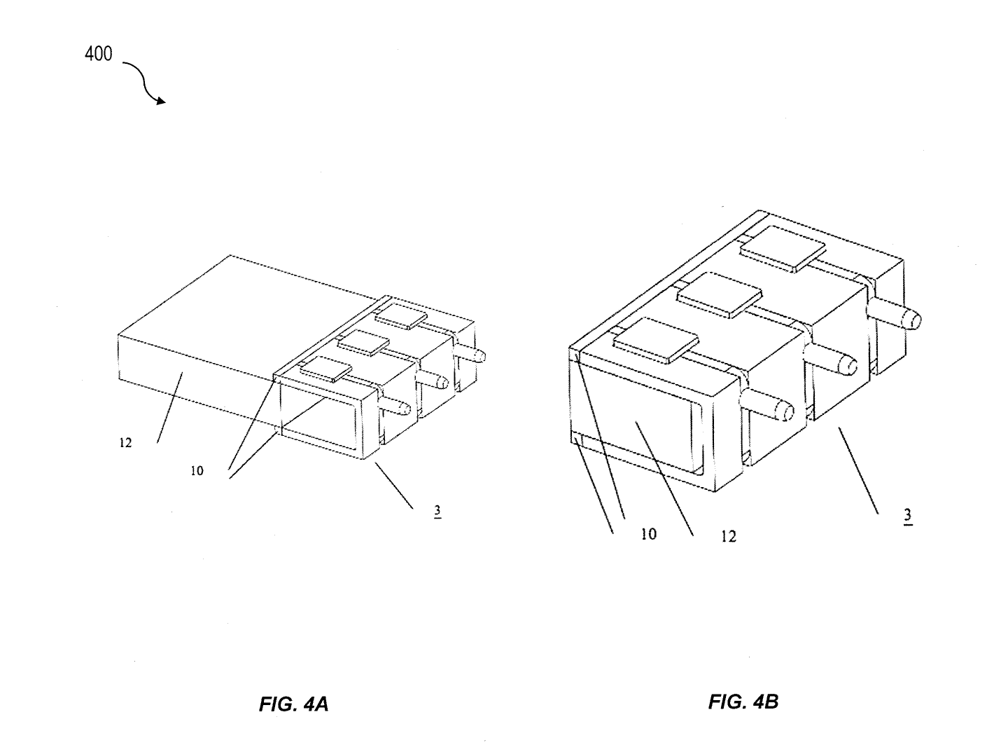

FIG. 3 shows a U-shaped, 3-phase array H-bridge 3 comprising six flat MOSFET wafers, or equivalent semiconductor switches 4 with associated conductors for connecting via three contacts 9 at the bottom of the U-configuration, in matching relationship with non-shorted ends of conductors 2 of a TTW 1. The switches also have conductors for connecting plus and minus-rails 10, see FIGS. 4a and b, of adjoining capacitor or battery 5, as the case may be. So for example, FIG. 4a shows a battery or capacitance 5 fitted on the inside of the H-bridge 3. FIG. 4 b shows an H-bridge where a relatively larger square battery cell 12 is connected on the outside of the U-shaped H-bridge 3 leaving room for optionally planting micro-channels inside of the U for improved cooling of the inverter chips 4.

A fortuitous match between the back EMF and current requirement of the single turn sub-mm range winding TTW 1 and the voltage and current of low impedance MOSFETs and the inherent voltage of battery cells 12 can exists in the apparatus and systems described herein, and the methods described herein can take advantage of the fortuitous match. Both the voltage and current of low impedance MOSFETs and the inherent voltage of battery cells 12 fall into the range of single digit voltage and current in the few tens of amperes. Low voltage MOSFET technology has advanced significantly over the years and moved into current densities in the range of thousands of Amps per square-centimeter taking advantage of the short thermal distance associated with low voltage devices. This results in higher power density switching and allows the construction of relatively large number of inverters on a single structure to drive the type of circuits shown in FIG. 1. The switches 4 are high current enhancement-mode MOSFETs, operated in pulsed mode and controlled via a central Motor Control Unit (MCU). Timing for the circuit is controlled by the MCU, by opening and closing the MOSFETs in pairs to provide the proper phase. The major design consideration for the H-bridge at this point is the proper selection of the MOSFET, with high-current capability and low cost being the most important parameters.

Based on collected data on available MOSFETs, the most suitable at the time of this writing is the IRL1404 from International Rectifier, delivering 160 A of continuous current at 25° C. and 640 A of pulsed current, with a VDSS of 40V. The device also features a very low on-resistance (RON) of 4 mΩ. As far as cost is concerned, the price per amp of current is quite low, with a single package listed at around $3.60, or $0.022 per amp. MOSFETs are clearly an attractive low-cost option as a high-current, low-voltage driver for motor applications. In addition, a number of other MOSFETs from International Rectifier and others are also available with higher current handling capabilities, currently as high as 429 A in continuous mode of operation, and 1640 A in pulsed mode, and are very competitive in terms of cost per amp.

### The Size of Magnetic Gap

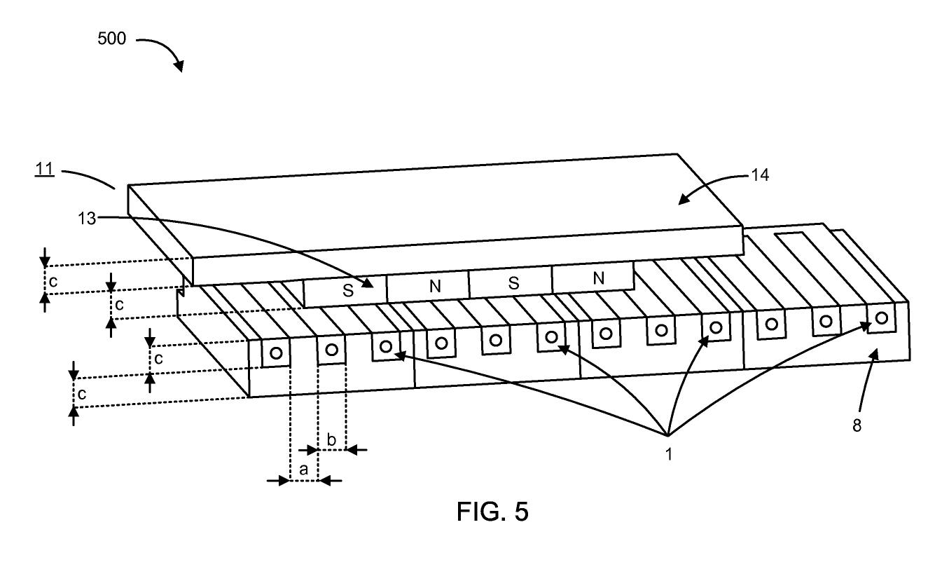

Undoubtedly, the magnetic gap is immensely important, as this is where in the interaction between the magnetic flux of the armature and the magnetic field from the TTW conductor interact to produce the shear force in the system. Referring now to FIG. 5, a portion of a motor element, or equally well applying to a linear motor or, if spread out a circular motor, is composed on the stator side of several side-by-side CTSs 6, as seen in the lower section of the figure. Across the air gap a portion of rotor or shuttle armature 11 is displayed in the lower section of the same figure. Alternating N and S permanent magnets 13, e.g. of type neodymium-iron-boron (NdFeB), are embedded in a matrix of ferromagnetic material 14. A pair of N-S magnets forms a magnetic dipole. There are indicated three critical dimensions labeled ‘a’, ‘b’, and ‘c’. These yield a dipole width of ‘3(a+b)’. The total stator height is suitably set equal to twice the conductor height, thus, it being ‘2 c’. The gap height maintained between the stator and the moving armature 11, however, needs to be smaller than or equal to the magnitude of ‘c’ to prevent loss of flux density in the gap. For this design consideration, the gap height, as well as, the dimensions ‘a’ and ‘b’ and the magnet and armature heights are all set equal to ‘c’, which is now referred to as being the pole size of the device. Therefore the total height the motor system is ‘5 c’ and the total width of a CTS forming a magnetic dipole is ‘6 c’. It is easily seen that as the pole size shrinks so does the volume per unit area. Thus, the total force being proportional only to the area, the resulting power density increases with smaller pole size while the losses increase due to diminished conductor cross section. Also, the surface to volume ratio increases which allows better cooling. To conclude, because the three dimensions are equal in magnitude, the overall system volume is determined by the pole size; reducing the pole size results in a smaller overall system volume, and thus, a larger power density. However, this does not come without a tradeoff.

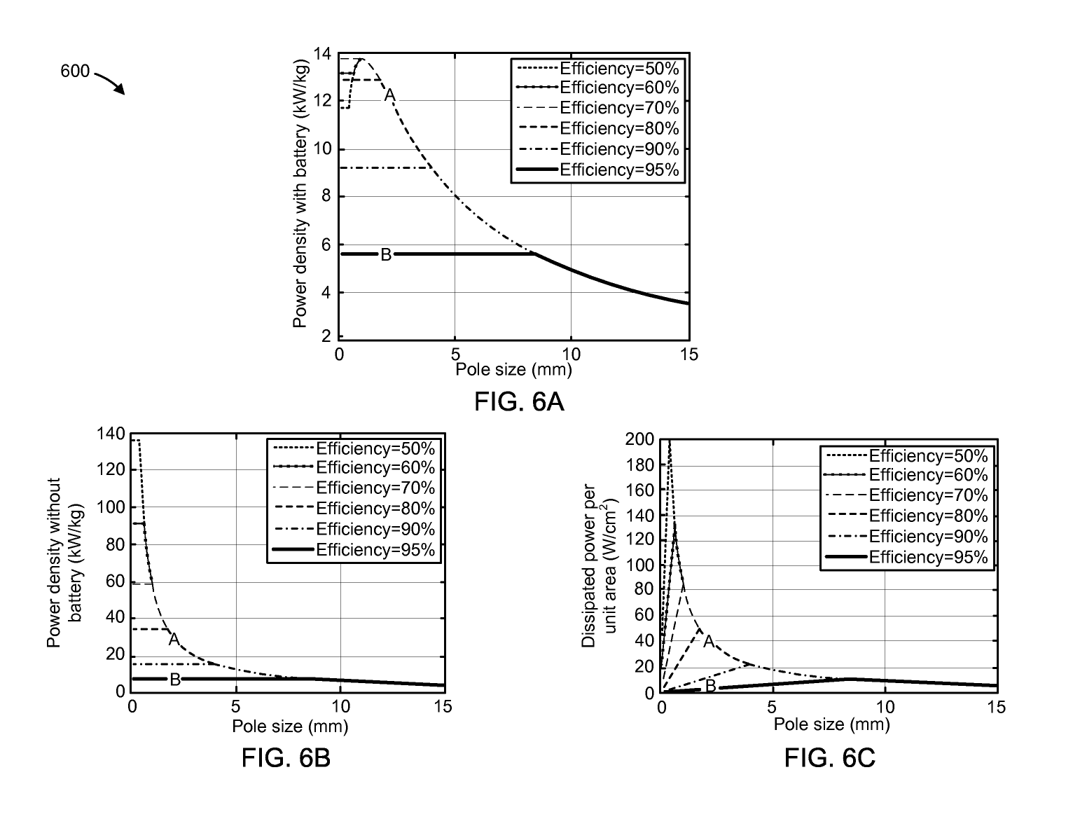

A reduction of the pole size yields a smaller conductor volume, which increases the resistivity, leading to higher resistive losses in the system. It is concluded, the trade-off is between the weight and volume of the system and the overall efficiency. This is illustrated in FIGS. 6a, and 6b showing a plots of power density vs. pole size, with and without battery 5 included. In both cases power density follows a hyperbolic curve but for a given small pole size, the power density saturates, commensurate with the capabilities of the permanent magnet material and the ferromagnetic substructure, dictating the attainable motor efficiency. The smaller the pole size the larger power density, but at the cost of lower efficiency. Note, the particular graphs in FIGS. 6a and 6c is for a surface velocity of 30 m/s. A higher power density obtains with increasing velocity; at similar efficiency the power density is proportional to the velocity squared. The graph in FIG. 6c, also derived for a surface velocity of 30 m/s, shows the associated dissipated power per unit area. Using a smaller pole size than that required for attaining a desired efficiency reduces the dissipation linearly to zero with diminishing pole size. An added advantage of moving to a smaller pole size is that with a smaller conductor and system volume, a greater ratio of surface area to volume occurs, which then improves the removal of heat. In this context it should be noticed that although with MEMS technology gaps less than 0.5 mm are practically feasible, roundness tolerances on the stator and rotor, and if bearings are preferred to eminently feasible electromagnetic gap control, the economic quality of the bearings will determine the minimum possible pole size.

Two basic categories of embodiments with application examples are will be presented below, aiming to illustrate the very broad realm of applications.

### Linear Motor Embodiments

Linear motor embodiments are broadly applicable to categories of linear motors in moving platforms, as in pallets and trains; or shuttles, as in actuators. These may have a flat or channel like stator, or advantageously an extruded track shape with congruently shaped platform/shuttle in order to provide lateral centering force.

### Example 1

### Slow Moving Flat Platform

Here is specialized to a flat platform movable over a track having a length exceeding that of the platform, as illustrated in FIG. 5. The modularly built track system comprises a number identical sub-modules composed of a moderate number of CTE base units. If a failure occurs within the system, the faulty sub-module only minimally affects the system's operation, hence graceful degradation. This sub-module can then be easily removed and swapped with a functional one, with the added benefit of simplifying the inventory of spare parts.

Typically, the sub-module contains a small number of basic units, for use in applications that require relatively small forces. When much larger forces are required, as in an elevator or the movement of cargo across the ship deck, the sub-modules can then be assembled with many more base units.

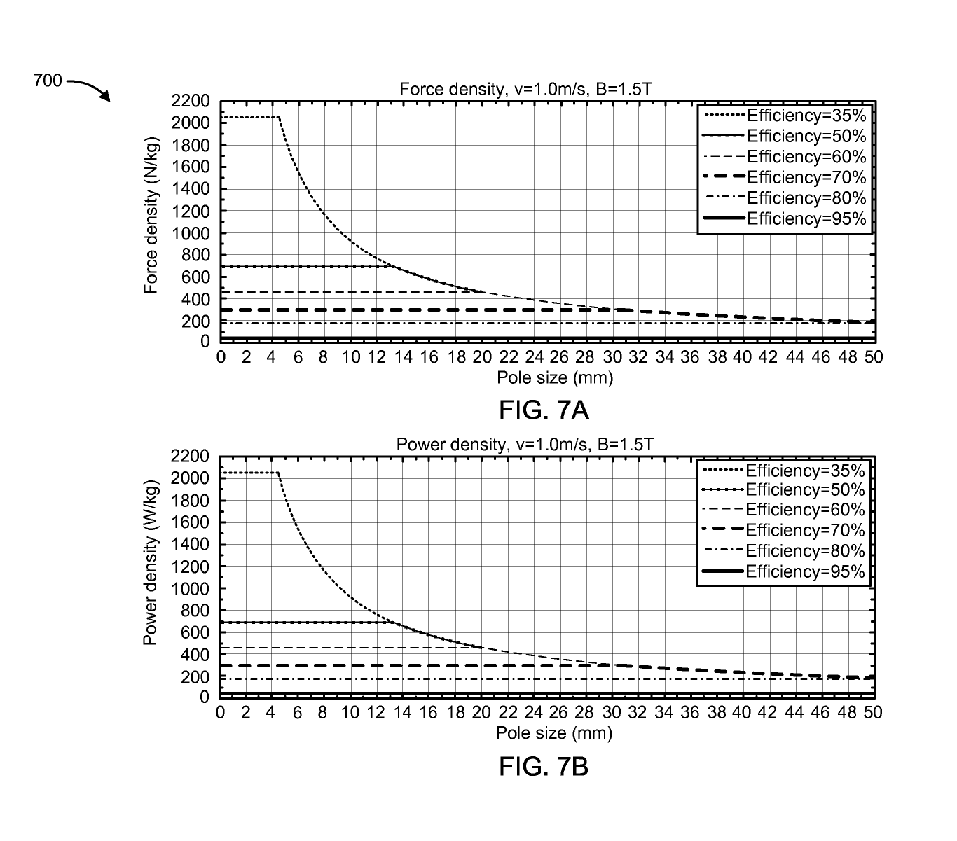

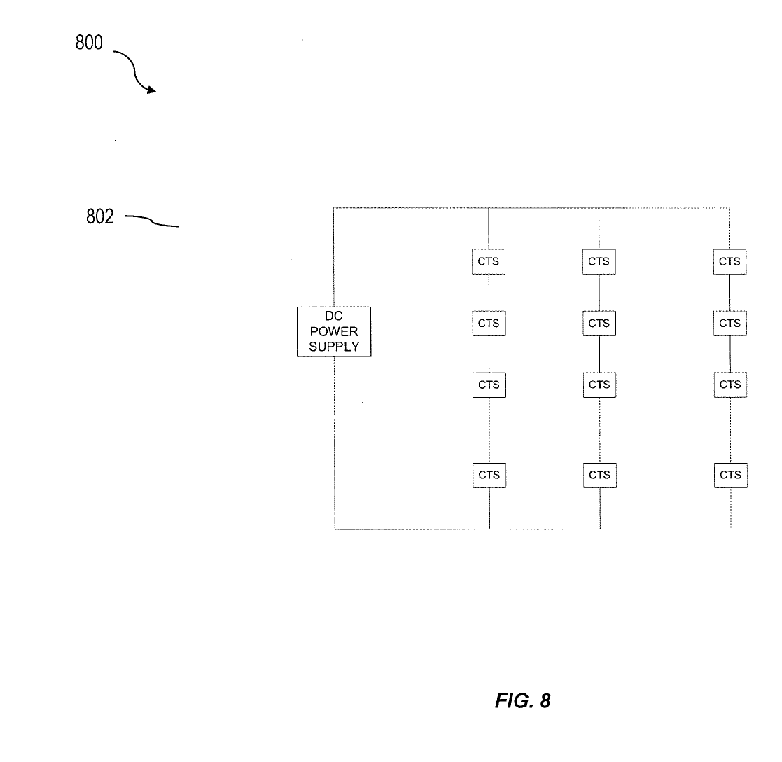

Referring to the graphs in FIGS. 7a and 7b, in order to quantify the effect of pole size on the characteristics of the system, first-principle calculations of the force and power density, in units N/kg and W/kg respectively, were performed using various levels of overall system efficiency, for a suitable platform velocity of 1 m/s. Characteristically force and power density increase substantially with diminishing pole size, up to a particular value, at which point saturation is observed, corresponding to magnetic saturation within the system. Another feature of the plots is that for a given pole size, both the force and power density increase as the efficiency decreases.

The linear motor can in principle, be operated at various points on these plots to accommodate the changing needs of the system. This dynamic tuning allows the system to operate in a low-efficiency state when large forces are needed, and a high-efficiency state for smaller forces, resulting in a more efficient system.

More specifically, the sizing based on first principles yielded the dimensions of the individual components: 12 mm×5 mm for the permanent magnets with a 2 mm×2 mm non-magnetic spacer, 5 mm×5 mm for the individual conductors, with a 5 mm×5 mm soft-iron spacer, and 5 mm×180 mm for the soft-iron of both the track and shuttle.

Most suitably, as in this embodiment, low-voltage Li-ion battery technology is integrated with low-voltage MOSFET. The low impedance environment enables the use of high current density, high current Li-ion batteries for power conditioning. While the individual battery cells provide the local current at low impedance, the cells are energized in series providing the proper EMF matching to conventional power sources. While the shuttle armature 11 is operated on a continuous basis, each length of track operates only while the shuttle armature is overhead. Therefore, the batteries operate for a brief period of time, and can then be recharged over a longer interval at lower currents and power, thereby reducing the weight of conductors.

Alternatively, by eliminating the series connection of the poles, a timing requirement is introduced, and this is one of the reasons for integrating each phase winding ensemble with a dedicated H-bridge. For the timing, each bridge receives an identical timing signal from a central motor control unit (MCU) processor, though flexibility in operation is introduced by also allowing for control via local sensory inputs. Local inputs could be used to control various parameters of the system, such as control of the gap size between track and shuttle, resulting in greater control over system performance.

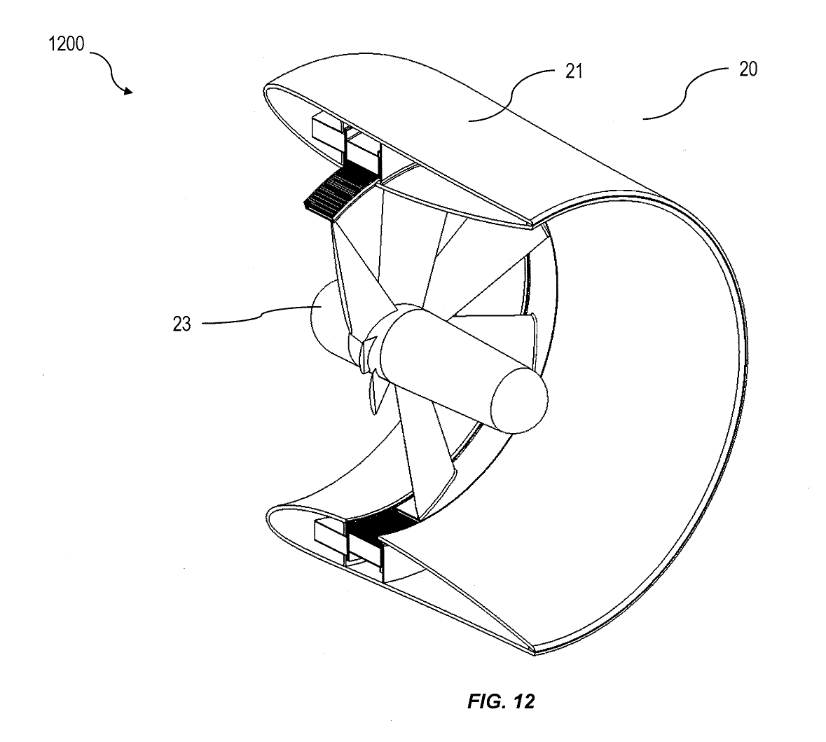

Although not limited to this particular embodiment, there are introduced individual DC storage batteries 12 literally taking the place of the previously specified capacitors or smaller batteries 5, in the CTEs 6. Referring to the schematic diagram in FIG. 12, the aforementioned storage batteries allow continuous charging in series or in series-plus-parallel of groups of CTEs at much higher voltage providing similar power supply characteristics to that of a conventional multi winding system. This results in confining ac currents only to the individual “active” CTEs, having the effect to cancel all external interconnection inductance limitations. The electromagnetic noise produced by this arrangement is drastically reduced which in turn reduces the EMI shielding requirements with their associated weight.

Because of the recent development of high power and high energy Li-ion based battery technology the cost, performance, and reliability meet the needs for this application. For the purpose of specifying this embodiment so that it can be brought into practice, there is introduced a high power version of the Li-ion battery as a power conditioning element. Typically, these batteries can discharge their energy on the order of one second, which matches the transit time of the shuttle moving at ˜1 m/s over a lm length of the track.

The batteries serve to provide high current densities locally to the linear motor, without having to supply large amounts of current from the power distribution system. Therefore, the power distribution system only has to provide the power to recharge the batteries. While the entire system is designed to run continuously, each segment of track is only active while the shuttle is positioned overhead. For example, in deck locomotion, assuming an arbitrary number of shuttles operating continuously, separated by 50 m and moving about at 1 m/s, each shuttle is above a one square-meter (m²) section of track for only 1 second. The batteries therefore discharge for a total of 1 second, and then have 50 seconds to recharge before the next shuttle arrives, allowing the batteries to recharge at a rate of, say 1/50^{th} of the total system power. To put the power in proper context, assuming two shuttles operating at 1 m/s and producing a force of 25 kN with 50% efficiency, the total continuous system power is 100 kW. Batteries throughout the track are continuously discharging this 100 kW to produce the force required to move cargo, and to ensure the batteries do not become depleted, the system must also be charged at 100 kW. But because the total area of the track occupied by the shuttles at any given moment is 1/50th, each local battery can charge at 1/50^{th} of the rate of discharge. For example, the commercially available advanced Li-Ion battery by Saft, Inc. operates at 0.5 A/cm² with a cell thickness of ˜50 μm and cell voltage of 3.6V. For the 100 kN/m² requirement corresponding to the elevator only, we need to supply upward of 2 kA/cm of track while the shuttle is overhead. A 2-liter battery per meter of track length and distributed in parallel matches the requirement. It can be arranged as part of the H-bridges as shown in FIG. 4b. In that case it will be 1 cm in height and will add an additional 20 cm to the 1-meter track width.

### Circular Motor/Generator Embodiments

The Circular Motor/Generator embodiments are broadly applicable to categories of circular motors or generators. These may have radial, diagonal or axial magnetic gap and the rotor may be either on the inside or on the outside of the stator. Note a diagonal gap is useful for centering of the rotor and reacting axial force acting on the same.

In the two Circular Motor/Generator embodiments there will be presented specific aspects relating to drum and disk shaped devices.

### Drum Shaped Devices

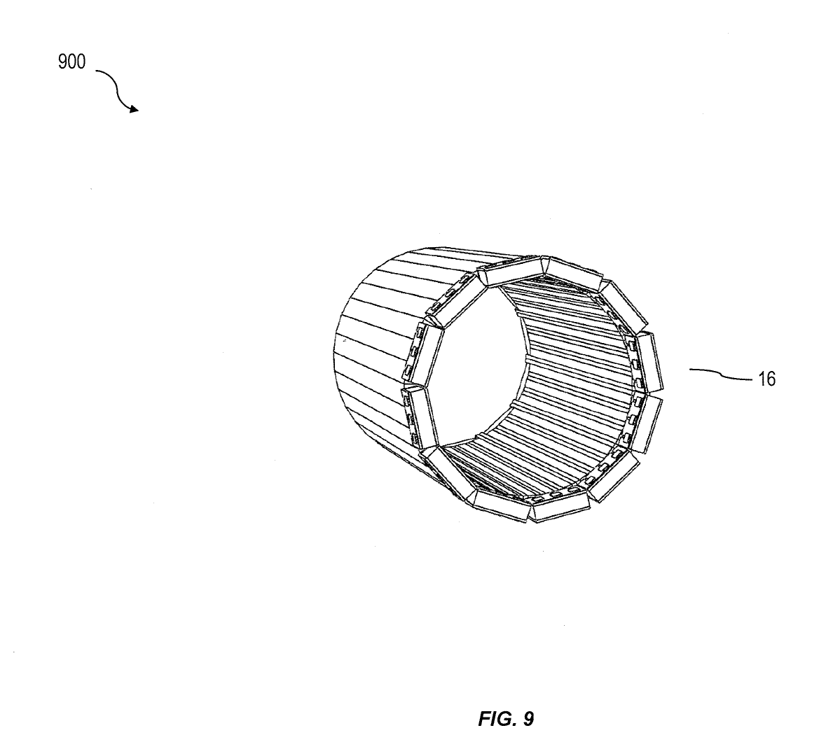

FIG. 9 illustrates an implementation a principle of an exemplary stator assembly of a radial magnetic gap, drum-shaped device having chord length longer than the diameter. To provide sufficient resolution in viewing of the ingredient components, FIG. 9 shows a small cylindrical stator assembly, made from only 12 standard CTSs 6, stacked side-by-side to form a less than perfect cylindrical structure, which in actuality is a 36-facetted regular polygon. With the c-dimension being, say 1 mm, there results an inner inscribed diameter of merely 22.8 mm, yielding an unwieldy, large thickness to radius ratio of 4×c/22.8=17.5%. This large thickness to radius ratio does not satisfy the intended configuration described elsewhere herein in greater detail, that is to say a configuration that includes thin structures with near perfect cylindrical bores accommodating very small flux gaps between stator and rotor.

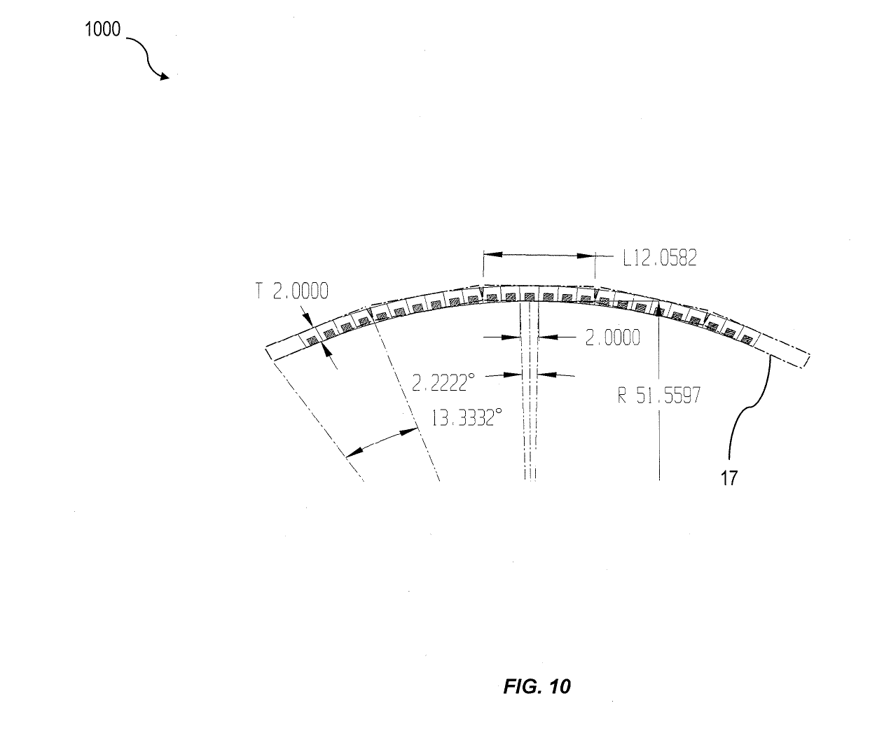

With larger assemblies, having smaller curvatures, it is economical to chain extend H bridges to encompass several TTWs. This becomes feasible as the central 3 contacts at the bottom of the U-configuration 9 of the H-bridge, see FIG. 3, have sufficiently overlapping contact areas with the associated conductors on the TTWs. There is now referred to FIG. 10 to better illustrate a possible principle for drum motor stator design synthesis. By way of example, here it takes 54 TTWs to make a 162-facetted regular polygon. With the c-dimension again being 1 mm, there results an inner diameter of about 103 mm and a corresponding thickness to radius ratio of 3.9%. The elongated rectangular areas indicated within dash-dot lines represent doublet-H bridges 17, thus, serving two TTWs at a time.

Now, one can obtain a rule for constructing the polygonal stator. With a devoted H-bridge per TTW, thus forming a CTE according to the foregoing, the number of polygonal facets, each having a conductor, must be an integer divisible by 3. Thus, with the doublet-H bridge 17 the number of polygonal facets must be an integer divisible by 6. With a triplet-H bridge the integer must be divisible by 9, and so on. To obtain an exactly desired inscribed cylinder ID it becomes necessary to make minor adjustments on the selected c-dimension. But this is only a partial requirement which must be supplemented with a more dominant smooth bore requirement stating that the relative difference between the corner radius and the inside radius of the polygonal facet should be less than about 0.01% yielding from geometry of regular polygons that number of poles should not be less than 222 with a corresponding thickness to radius ratio of 2.8%.

Now with small devices say with radius less than 71 mm and larger devices where power density is important, this yields pole size “c” in the sub-mm range. Then advantageously MEMS technology is the preferred approach for producing the multitude of tiny conductor slots 7 advantageously in a planar sheet of matrix material 8, which can then be rolled into a full cylinder or alternatively pressed into two half-cylinders for later assembly with conductors electroplated in slots after obtaining final shape.

With such small thickness to radius ratio it is not necessary to settle for chaining H-bridges to encompass, even as it entails imperfect matching as illustrated in FIG. 10, only a few TTWs 1 but it becomes perfectly feasible to repeat U-shaped H-bridges 3 initially in a flat assembly to cover the entire perimeter of the TTWs and then elastically deforming the resulting continuous assembly into a matching annular H-bridge 32. This is later cured relieving residual stresses.

### Disk Shaped Devices

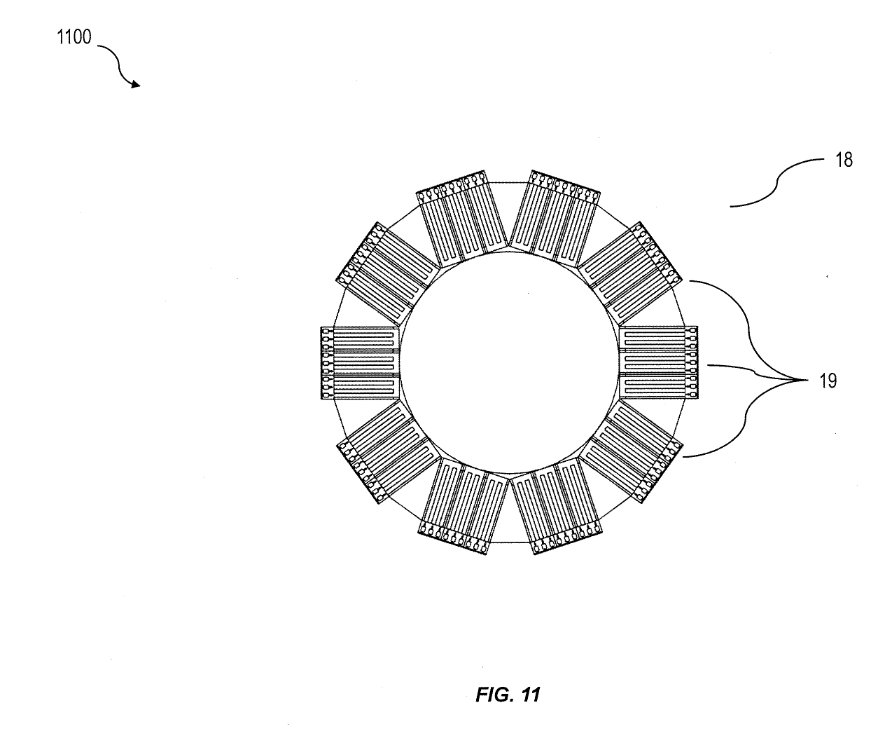

Making an axial gap disk shaped device is particularly fortuitous, since the stator matrix 8 is by its very nature planar facilitating to produce slots 7 by MEMS technology, highly suitable for achieving a repeating pattern of small accurately sized poles. The slots 7 may be parallel and TTWs arranged in clusters, so as to form a polygonal outer perimeter suitable for attaching un-interrupted, straight H bridges 3, e.g., triplet H-bridges 19, such as shown in FIG. 11. It is also possible here while using MEMS technology to have conductors oriented radiating from the center.

### Example 2

### Ducted Ring Fan Propulsor for Electric Flight

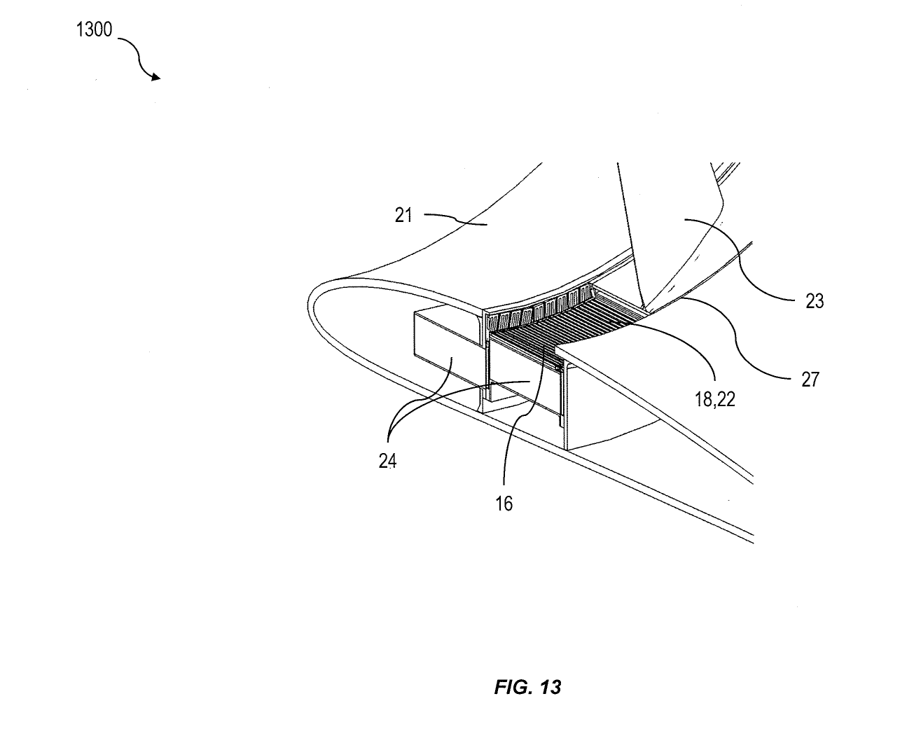

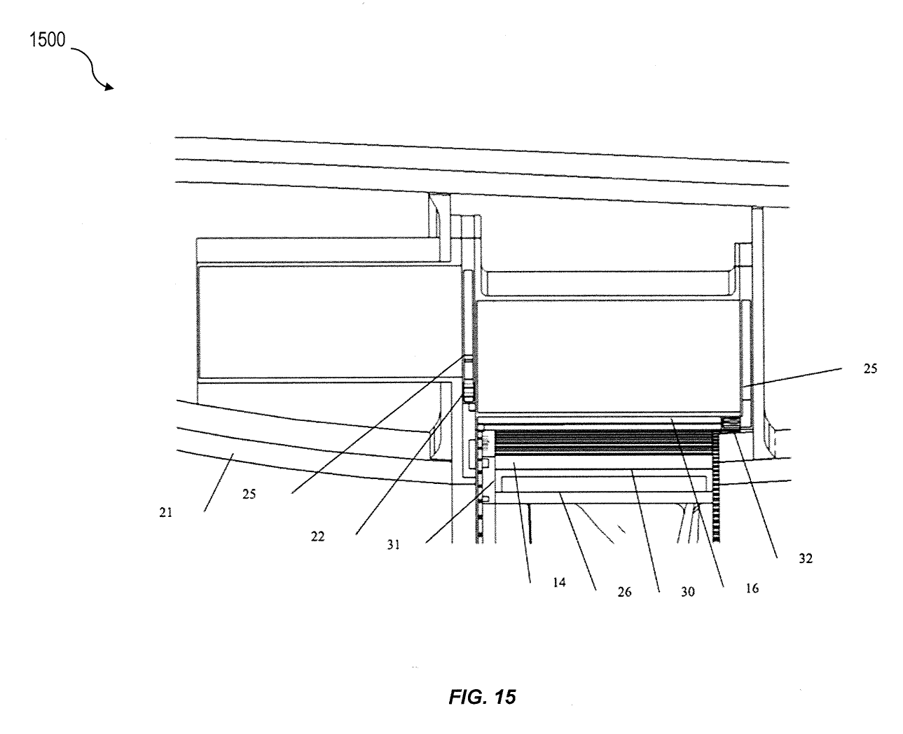

FIGS. 12 through 15 illustrate an electric rim-motor driven ducted ring-fan propulsor 20, as described herein. Assuming an aircraft in the 10,000 Lb class flying at 10,000 m altitude at a cruise speed of 350 mph and having a Lift to Drag ratio of 15, yielded: fan radius 500 mm, tangential speed of 122 m/s. At these conditions a single propulsor produces a thrust of 3 kN and draws 800 kW electric power with an all-inclusive propulsion efficiency of nearly 85%.

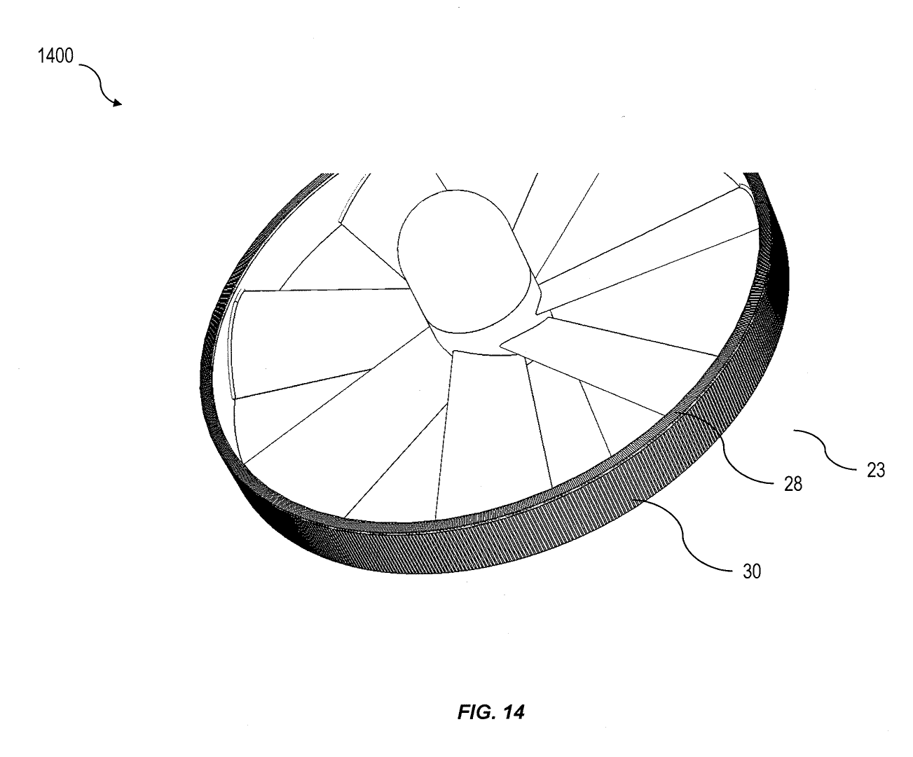

The air duct, in this case embodied by a freely supported nacelle 21, e.g. by a pylon, houses two independent rim-motor stator assemblies. The first assembly, a drum-shaped stator 16 akin to the one shown in FIG. 9, but having much smaller curvature, is provided for affecting rotating magnetic field for propulsion, as well as, active feed-back azimuthally varying push/pull radial field dynamic centering and gap control. The second assembly, a disk-shaped stator 18 akin to the one shown in FIG. 11 but having clusters comprising sextet H-bridges 22, is provided to affect magnetic dynamic bucking force acting on the ring-fan 23 and again axial gap control. The nacelle 21 also houses modular batteries 24, tied to H-bridges 3 via adaptor rings 25, where the batteries have sufficient mission determined energy storage for minutes of silent flight mode. The ring-fan 18 is disposed with its peripheral ring 26 in a circumferential slot 27 provided in the throat region of the convergent-divergent nacelle 21 and having the inside ring surface 28 substantially flush, in smooth transition with the nacelle throat contour. This is advantageous for mitigating, even eliminating blade tip vortices. Referring to FIG. 14, the peripheral fan-ring 29 supports on the outside peripheral face 30 and on one side face 31 permanent magnet rotor parts relating to the stator assemblies, thus, completing the rim-motor drive design.

The present motor design uses a much smaller pole size than conventional motors. It is around 1 mm which is the key contributor to high power density, as elaborated above. The resulting small thickness to radius ratio of the stator 16 lends itself cover the entire perimeter of TTWs 1 with a matching, continuous annular H-bridge 32.

The absence of turns lowers the drive voltage (back EMF) to the 25V range. This in turn allows the use of the higher power density semiconductor switching in the inverters, and it also allows the use of multiple inverters on single chips, which are directly coupled to the turnless structure arrays. The resulting overall inverter size required to power the motor is drastically reduced in comparison to conventional inverter technology. The low drive voltage matches admirably the higher power density MOSFETs presently being developed, particularly for the low voltage personal electronics, e.g. 25 V MOSFETs have a design current density of 8 kA/cm2, which corresponds to 100 kW/cm2. Here is planned to use a more conservative 50 kW/cm2 switching power.

The same trends are at hand as discussed before concerning the relationships for how the power density, efficiency, and dissipation per unit area vary with pole size. In this case with the 1 mm pole size in conjunction with the high velocity of 122 m/s, the drum shaped rim motor part has an estimated weight of only about 14 kg and electric efficiency of around 99.6%.

The thrust bearing differs from state of the art magnetic concepts using inductively induced eddy currents that are on continuously and thus, become overly dissipative. Instead the approach described herein uses the present inverter controlled turnless structure to generate the required currents for producing the required thrust at the appropriate gap. The dynamic gap control minimizes the dissipated power for this function.

The independent inverters and their individually dedicated batteries 24 serve three functions: i) The high power density battery technology used here (Saft high power) is adequate to supply the instantaneous current for the inverter and thus provide the power conditioning normally achieved with capacitors. ii) The individual inverter—battery combos driving each TLS can be connected directly in either parallel, series, or combination thereof since they are on the DC side of each inverter. A series connection results in high DC voltage which is advantageous for transmission from the generator. The same arrangement on the generator results in high voltage output while the generated voltage remains in the low voltage of this turnless configuration. iii) The amount of batteries used here is increased to accommodate the silent running and additional surge power for a scram flight mode. The inverter triggering signals for rotation come from one master MCU, while the radial forces modify the phase of the switching locally as required by gap sensing.

The large plurality of the magnetic circuit around the periphery of the motor, makes the motor relatively immune to individual failure of one such circuit. This is in contrast to a typical motor multi turn winding where a single winding failure in either short or open will fail a major part of the motor. This graceful degradation can be used to reduce the conventional design safety factors and thereby enhance the overall performance of the electric flight propulsor.

### Example 3

### Hybrid with Combination Fuel Powered Engine Generator for Low Steady Cruise Power and Appended Energy Storage—High Power-Burst Acceleration Motor

Increasing passenger car fuel efficiency presently mostly implies reducing the performance through cutting curb weight, engine power, cruising speed and range, in various mixtures of the four, while maintaining a minimum standard connected with the dual safety requirements of a minimum weight of around 3000 Lb and safe acceleration to 70 MPH in about 10 second on freeway ramps. This translates to a power requirement of about 180 hp, which is used for short periods, say 10 times a day. Consequently, each 10 sec period of acceleration requires approximately 1 MJ of energy, a rather modest amount. On the other hand, cruising at 70 MPH requires only 20 hp and much of the time even less, while cruising up a grade requires but a total of 30 to 40 hp. Thus, with engine sized at 180 hp, it is operated predominantly at 10-20% of its maximum capacity. Fuel efficiency of a standard automotive engine as function of percent power used typically has a rapidly rising efficiency in the 0-20% power range to an efficiency of around 20% which then levels off reaching about 30% at full power. Accordingly, the average mileage efficiency is merely around 20% instead of reaching the engine's full potential of 30%, indicating a possible 50% improvement if removing the acceleration duty.

The present example introduces a separate “Acceleration Pack” to provide the 180 hp at the wheels for acceleration and regeneration for full performance and energy recovery while the fuel burning engine need not exceed 35 hp to accommodate 70 MPH cruising speed up a grade and the operation of auxiliaries such as air conditioning. With all variable speed requirements, thus, removed from the engine efficiencies commensurate with the engine's maximum efficiency can be achieved by having the nominal 35 hp power plant operate at high RPM and directly driving an alternator similar to an auxiliary power unit (APU). This holds out the prospect of achieving mileage efficiencies approaching 35% to 40% and even considering a more modest efficiency of 30% a mileage of 60 MPG cruising at 70 PMH is achievable in a full 3000 Lb American car with standard frontal cross section of 1.8 m².

The key component in the Acceleration Pack is an extremely high power density electric motor-generator with integrated inverter and battery. Its enhanced power density is partly the result of applying unique MEMS architecture allowing the construction of a turn-less design with poles down to 1-2 mm size range, as described herein. By moving to smaller pole sizes, the total weight and volume of the system decrease substantially, resulting in an overall higher power density.

FIGS. 6a, b and c show the drastic improvement in power density, with the integrated battery (a) and without (b), and the cooling capacity (c) as the pole size is reduced to the mm scale. As can be seen, the mm pole size exhibits an order of magnitude higher power density with an optimum around 2 mm pole size. Furthermore, the capacity to remove heat increases with smaller pole sizes, as the surface area to volume ratio increases. The 2 operating points of interest are labeled A and B on the figures. Point A is the operating point at maximum acceleration, putting out 180 hp for approximately 10 seconds (slower accelerations are longer in duration but require correspondingly less power), with an efficiency of around 70%. Point B is the operating point during cruising and hill climbing, at which point the power is less than 40 hp and efficiency of the motor is in excess of 95%. FIG. 6c shows the heat removal requirement, which decreases dramatically with pole size at the respective operating points. At point A in FIG. 6a the resulting power density is 14 kW/kg and so there is obtained 140 kW=185 hp with a 10 kg motor. While this number includes mass of battery commensurate with required stored energy of 1 MJ, as derived above, in order to accommodate multiple accelerations in succession it is estimated the required energy storage is 5 times greater. This is available from 10 kg of present state of the art Li-Ion batteries.

To summarize a total mass of 20 kg for both battery and motor is a conservative design. To put this in context, virtually all hybrid concepts of comparable performance necessitate smaller and lighter cars and smaller frontal cross-section to minimize wind resistance, of which, the Prius® is a good example. A conventional 180 hp motor battery system is at least 10 times heavier than the present motor alone of the Acceleration Pack, and its battery is a high energy storage battery, rather than the high power battery used here. In addition, the present hybrid concept allows the use of a much higher efficiency single-speed low-power fuel-burning engine resulting in reduced engine weight by a factor of up to 5 and over-all weight saving of up to a thousand pounds.

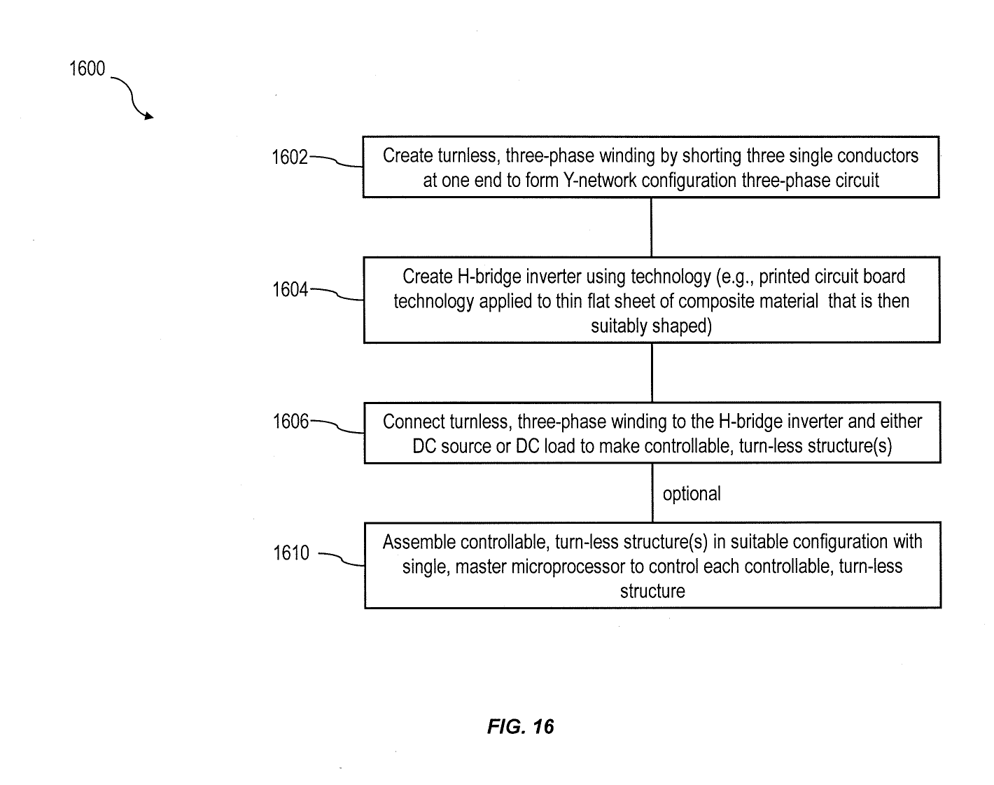

FIG. 16 shows a method 1600 for making a controllable, turn-less structure, and optionally, in turn, a stator that is composed of an assembly of separately controllable turn-less structures. The steps indicated in FIG. 16 can be executed in any suitable manner, so long as the combination of the steps results in a controllable, turn-less structure with a turnless three-phase winding, an H-bridge inverters, and either a DC source or a DC load. As described further herein above, turnless, three-phase windings can be made by shorting three single conductors as one end to form a Y-network configuration three-phase circuit, as shown in 1602. Making turnless, three-phase windings can be done using micro-or nano-fabrication technology, such as that used to make MEMS. In making the controllable, turn-less structures described herein, at least one H-bridge inverter must be created, as in 1604. H-bridge inverters can be made using printed circuit board technology applied to thin flat sheet of composite material that is then suitably shaped. A controllable, turn-less structure is made by connecting, or assembling, the turnless, three-phase winding to the H-bridge inverter and either a DC source or DC load, as shown in 1606. The nature of the final apparatus or device will dictate whether a DC source or load is included in the controllable, turn-less structure, as mentioned above. A motor requires a power source, and a generator requires a load. In FIG. 16, creating a stator is shown as optional (box 1610). Creating a stator as described in greater detail elsewhere herein involves assembling controllable, turn-less structures in a suitable configuration, such as a drum, disk, or arm, with a single, master microprocessor that can control each controllable, turn-less structure individually.

### Application Areas

Manifestations of the apparatus and systems described herein are scalable from miniature actuators and motors to large moving cargo pallet ship deck applications and from extremely slow velocity actuators to high speed EM gun applications. Of necessity the different applications see different parameter values but the common thread is the independent drive with H-bridges of three phase elements with no turns. At the smallest feature size consistent with the requirements these are manufactured with the appropriate MEMS manufacturing techniques, e.g. LIGA, EDM and the like. Especially promising, seems the following:
i. Hybrid cars, buses and trucks and heavy equipment.

The extremely high power density of this motor technology in conjunction with its enhanced cooling ability has been identified as a key element in a hybrid power train for cars and busses, where peak to average power ratio is very large, wherein optionally speaking, each wheel may be powered by a light-weight reversible motor also serving as both drive and braking feature.
ii. Marine propulsion for ships and ferries

The inherent substantial weight/volume reduction and reliability enhancement lends itself well to this application, for example, one having a marine gas turbine prime mover driving a high-speed alternator providing electric power for a low-speed propeller drive motor.
iii. Auxiliary power unit generators for military tanks and marine environments

Auxiliary power units (APU) are typically optimized at high speed which in turn has its efficiency limited by the sustainable gap between rotor and stator. A variation on the novel motor produces a generator taking advantage of the independent excitation that allows for dynamic gap control. This results in the device having both high efficiency and very high power density.
iv. Ducted Fans for propulsion and lift in aircraft and air cushion crafts

This has many commonalities with the described marine propulsion application. An examples of ducted fan propulsors are described in “Development of a 32 inch Diameter Levitated Ducted Fan Conceptual design”, NASA/TM-2006-214481. Apparatus and systems described herein, by virtue of their high efficiency and power density, are particularly well suited to this type of application. An embodiment example of this will be described in further detail herein.
v. Windmill direct drive generators

The key limitation of windmills currently is the high cost and vulnerability of the gearbox. A light-weight direct drive replacement with extensive redundant pole control will provide a unique solution here.
vi. Turret drive systems

The applied very large ring gear, as used in conventional design, can be replaced in turret drive systems by an annular, conical surface holding stator. Such a motor drive can display lower weight, and faster and more precise motion control than present state of the art.
vii. Linear Actuators for flight control, factory automation, robotics, antenna surface modulators, etc.

Actuators are inherently limited in power density due to their low velocities. A MEMS scale version has already demonstrated high efficiency, power density and reliability. Dynamic control of antennas is an important area where large antenna gains can be obtained for both transmitting and receiving. As an important adjunct as antenna surface modulators they are capable of generating complex magnetic field patterns on surfaces to dynamically shape the radiating surfaces for precise phase control
viii. Computer aided machine tool control and rapid prototyping

Computer aided machining (CAM) requires rapid motion and control of cutting parts with great precision. Gear reductions possess an inherent ‘play’ that reduces positioning accuracy, therefore a high force direct-drive motor with a small footprint is desired here.
ix. In satellite reaction flywheels

Motor drives need very high power to weight ratios and the apparatus, systems, and methods described herein impact the performance in weight, efficiency and graceful degradation so needed in space-borne applications.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A device, comprising:
a turnless, three-phase winding; and
a H-bridge inverter;
wherein the turnless, three-phase winding comprises:
three single conductors connected at one end, such that the connected single conductors form a Y-network configuration, three-phase circuit.

2. A system, comprising:
two or more controllable, turnless devices, each device comprising:
a turnless, three-phase winding; and
a H-bridge inverter;
a power source or a load; and
a master microprocessor configured to control each controllable, turnless device independently.

3. A method, comprising:
creating a turnless, three-phase winding;
creating an H-bridge inverter;
connecting the turnless, three-phase winding and H-bridge inverter to make a controllable, turn-less structure.

4. The method of claim 3, further comprising connecting a DC power source to the turnless, three-phase winding and H-bridge inverter.

5. The method of claim 3, further comprising assembling multiple controllable, turn-less structures into a suitable configuration with a single, master microprocessor.
